(19) United States
(12) Patent Application Publication
(10) Pub. No.: US 2016/0092889 A1
(43) Pub. Date: Mar. 31, 2016

(54) SYSTEMS AND METHODS FOR FACILITATING LEAD DISTRIBUTION

(71) Applicant: Manheim Investments, Inc., Atlanta, GA (US)

(72) Inventors: Mark Humble, Atlanta, GA (US); Michael Rock, Atlanta, GA (US)

(21) Appl. No.: 14/496,409

(22) Filed: Sep. 25, 2014

(51) Int. Cl. G06Q 30/02; G06Q 30/06

(52) U.S. Cl. CPC G06Q 30/0201; G06Q 30/0625

(57) ABSTRACT

Systems and methods are provided for facilitating lead distribution. A method may include determining, by a service provider server that includes one or more processors, vehicle search information associated with one or more consumers. The method may include accessing lead preference information associated with a dealer. The method may also include aggregating vehicle search information associated with one or more consumers and generating, based at least in part on the vehicle search information, one or more vehicle leads. The method may also include comparing lead criteria information and the lead age information associated with a respective vehicle lead with the lead preference information and determining, based at least in part on the comparison, that the respective lead is to be provided to the dealer. Furthermore, the method may include transmitting the respective vehicle lead to a dealer device associated with the dealer.

### TECHNICAL FIELD

The present disclosure generally relates to automotive transactions, and more particularly to facilitating lead distribution.

### BACKGROUND

Automotive dealers, wholesalers and/or other types of retails are often searching for vehicle leads in order to identify consumers that are likely to purchase a vehicle. Identifying and discovering leads can be time-consuming process. Furthermore, vehicles leads may frequently be of low quality, thereby resulting in additional inefficiencies and cost.

### BRIEF DESCRIPTION OF THE DRAWINGS

Reference will now be made to the accompanying figures and diagrams, which are not necessarily drawn to scale, and wherein:

FIG. 1 shows a system for facilitating lead distribution according to one or more example embodiments.

FIG. 2 shows a data flow diagram related to lead distribution according to one or more example embodiments.

FIG. 3 shows a flow diagram of a method for generating vehicle leads according to one or more example embodiments.

FIG. 4 shows a flow diagram of a method for vehicle lead distribution according to one or more example embodiments.

### DETAILED DESCRIPTION

In the following description, numerous specific details are set forth. However, it should be understood that embodiments of the present disclosure may be practiced without these specific details. In other instances, well-known methods, structures, and techniques have not been shown in detail in order not to obscure an understanding of this description. References to “one embodiment,” “an embodiment,” “example embodiment,” “various embodiments,” and so forth indicate that the embodiment(s) of the present disclosure so described may include a particular feature, structure, or characteristic, but not every embodiment necessarily includes the particular feature, structure, or characteristic. Furthermore, the repeated use of the phrase “in one embodiment” does not necessarily refer to the same embodiment, although it may.

As used herein, unless otherwise specified, the use of the ordinal adjectives “first,” “second,” “third,” etc., to describe a common object merely indicates that different instances of like objects are being referred to and are not intended to imply that the objects so described must be in a given sequence, either temporally, spatially, in ranking, or in any other manner.

As used herein, unless otherwise specified, the term “device” refers, in general, to an electronic communication device, both wired and wireless, and more particularly to one or more of the following: a portable electronic device, a telephone (e.g., cellular phone, smartphone), a computer (e.g., laptop computer, tablet computer, desktop computer, wearable computer), a portable media player, a personal digital assistant (PDA), a kiosk computer for public use, or any other electronic device having a networked capability.

As used herein, unless otherwise specified, the term “server” may refer to any computing device having a networked connectivity and configured to provide one or more dedicated services to clients, such as a mobile device. The services may include storage of data or any kind of data processing. One example of a central server may include a web server hosting one or more web pages. Some examples of web pages may include auction web pages, dealer web pages, bidder web pages, vehicle information web pages, and/or the like. Another example of a server may be a cloud server that hosts web services for one or more computer devices.

As used herein, unless otherwise specified, the term “web page” may correspond to one or more web pages as part of one or more websites, mobile-optimized websites or automatically-optimized websites.

According to one or more embodiments of the disclosure, a method is provided. The method may include accessing, by a service provider server that includes one or more processors, lead preference information associated with a dealer, the lead preference information indicating one or more desired vehicle lead attributes by the dealer. The method may also include aggregating vehicle search information associated with one or more consumers and generating, based at least in part on the vehicle search information, one or more vehicle leads. Additionally, the method may include identifying a respective vehicle lead from the one or more vehicle leads, wherein the respective vehicle lead comprises lead criteria information and lead age information, and wherein the respective vehicle lead is associated with a respective consumer of the one or more consumers. The method may also include comparing the lead criteria information and the lead age information with the lead preference information associated with the dealer and determining, based at least in part on the comparison, that the respective lead is to be provided to the dealer. Furthermore, the method may include transmitting the respective vehicle lead to a dealer device associated with the dealer.

According to one or more embodiments of the disclosure, a system is provided. The system may have at least one processor and at least one memory storing computer-readable instructions. When the instructions are executed by the at least one processor, the instructions may cause the at least one processor to access lead preference information associated with a dealer, the lead preference information indicating one or more desired vehicle lead attributes by the dealer. The instructions may also cause the at least one processor to aggregate vehicle search information associated with one or more consumers and generate, based at least in part on the vehicle search information, one or more vehicle leads. The instructions may further cause the at least one processor to identify a respective vehicle lead from the one or more vehicle leads, wherein the respective vehicle lead comprises lead criteria information and lead age information, and wherein the respective vehicle lead is associated with a respective consumer of the one or more consumers. Moreover, the instructions may cause the at least one processor to compare the lead criteria information and the lead age information with the lead preference information associated with the dealer and determine, based at least in part on the comparison, that the respective lead is to be provided to the dealer. The instructions may further cause the at least one processor to transmit the respective vehicle lead to a dealer device associated with the dealer.

According to one or more embodiments of the disclosure, a non-transitory computer-readable medium is provided. The non-transitory computer-readable medium may have embodied thereon instructions executable by at least one processor. The instructions may cause the at least one processor to access lead preference information associated with a dealer, the lead preference information indicating one or more desired vehicle lead attributes by the dealer. The instructions may also cause the at least one processor to aggregate vehicle search information associated with one or more consumers and generate, based at least in part on the vehicle search information, one or more vehicle leads. The instructions may further cause the at least one processor to identify a respective vehicle lead from the one or more vehicle leads, wherein the respective vehicle lead comprises lead criteria information and lead age information, and wherein the respective vehicle lead is associated with a respective consumer of the one or more consumers. Moreover, the instructions may cause the at least one processor to compare the lead criteria information and the lead age information with the lead preference information associated with the dealer and determine, based at least in part on the comparison, that the respective lead is to be provided to the dealer. The instructions may further cause the at least one processor to transmit the respective vehicle lead to a dealer device associated with the dealer.

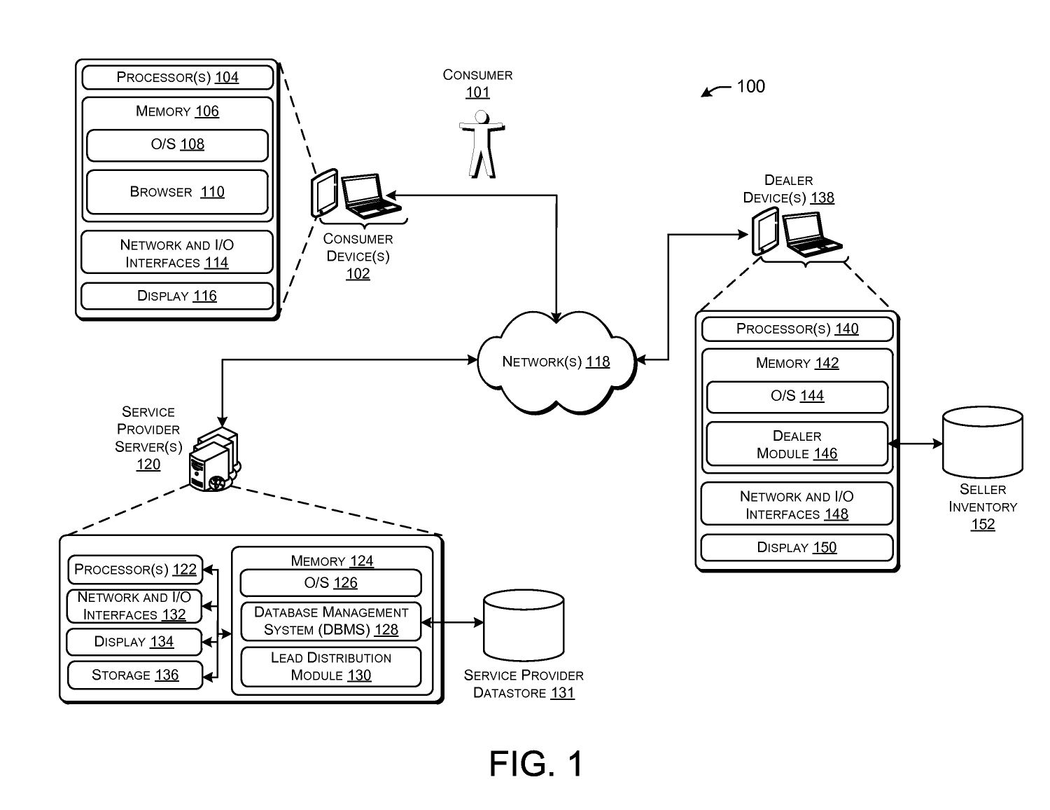

The above principles, and perhaps others, are now illustrated with reference to FIG. 1, which depicts a system 100 for facilitating lead distribution in accordance with one or more example embodiments. The system 100 may include one or more consumer devices 102 associated with one or more consumers, such as consumer 101. The consumer device(s) 102 may be in communication, via one or more network(s) 118, with one or more service provider server(s) 120, and/or one or more dealer device(s) 138.

In general, the consumer device 102 may refer to any type of electronic device, and, more particularly, may refer to one or more of the following: a wireless communication device, a portable electronic device, a telephone (e.g., cellular phone, smart phone), a computer (e.g., laptop computer, tablet computer), a wearable computer device, a portable media player, a personal digital assistant (PDA), smart TV or set-top box, or any other electronic device having a networked capability. The consumer device(s) 102 may include one or more computer processors 104, and a memory 106 storing an operating system (O/S) 108 and a bidder module 110. In addition, the consumer device(s) 102 may include one or more network and I/O interfaces 114, and a display 116. In certain embodiments, the consumer device(s) 102 may include one or more sensors capable of gathering information associated with a present environment of the consumer device(s) 102, or similar hardware devices, such as a camera, microphone, antenna, a gesture capture or detection device, or Global Positioning Satellite (GPS) device.

The computer processors 104 may comprise one or more cores and may be configured to access and execute (at least in part) computer-readable instructions stored in the memory 106. The one or more computer processors 104 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The consumer device 102 may also include a chipset (not shown) for controlling communications between the one or more processors 104 and one or more of the other components of the consumer device 102. In certain embodiments, the consumer device 102 may be based on any type of computer architecture (e.g., an Intel® architecture or an ARM® architecture). The one or more processors 104 may also include one or more application-specific integrated circuits (ASICs) or application-specific standard products (ASSPs) for handling specific data processing functions or tasks.

The memory 106 may include one or more computer-readable storage media (CRSM). In some embodiments, the memory 106 may include non-transitory media such as random access memory (RAM), flash RAM, magnetic media, optical media, solid state media, and so forth. The memory 106 may be volatile (in that information is retained while providing power) or non-volatile (in that information is retained without providing power). Additional embodiments may also be provided as a computer program product including a transitory machine-readable signal (in compressed or uncompressed form). Examples of machine-readable signals include, but are not limited to, signals carried by the Internet or other networks. For example, distribution of software via the Internet may include a transitory machine-readable signal. Additionally, the memory 106 may store an operating system 108 that includes a plurality of computer-executable instructions that may be implemented by the computer processor to perform a variety of tasks to operate the interface(s) and any other hardware installed on the consumer device 102. The memory 106 may also store content that may be displayed by the consumer device 102 or transferred to other devices (e.g., headphones) to be displayed or played by the other devices. The memory 106 may also store content received from the other devices. The content from the other devices may be displayed, played, or used by the consumer device 102 to perform any necessary tasks or operations that may be implemented by the computer processor or other components in the consumer device 102.

The memory 106 may also include an operating system (0/S) 108, which may provide an interface between other application software executing on the consumer device 102 and hardware resources of the consumer device 102. More specifically, the operating system 108 may include a set of computer-executable instructions for managing hardware resources of the consumer device 102 and for providing common services to other application programs (e.g., managing memory allocation among various application programs). The operating system 108 may include any operating system now known or which may be developed in the future including, but not limited to, any bidder operating system, any server operating system, any mainframe operating system, or any other proprietary or freely available operating system.

The memory 106 may also include a browser 110, which may be configured to enable a consumer 101 to interact with various websites, search engines, and/or the like. For example, the consumer 101 may use the browser to navigate to various vehicle retailer web pages to browse for one or more vehicles. The consumer 101 may also use the browser 110 to access search engines to facilitate a search for one or more vehicles. Furthermore, the consumer 101 may also use the browser 101 to interact with one or more social media sites, such as to post various thought, comments, opinions, and/or any other type of information associated with vehicles.

Referring again to the consumer device 102, the one or more network and I/O interfaces 114 may include one or more communication interfaces or network interface devices to provide for the transfer of data between the consumer device 102 and another device (e.g., network server) via one or more networks, such as 118. The communication interfaces may include, but are not limited to: personal area networks (PANs), wired local area networks (LANs), wireless local area networks (WLANs), wireless wide area networks (WWANs), and so forth. The consumer device 102 may be coupled to the network via a wired or wireless connection. Wireless system interfaces may include the hardware and software to broadcast and receive messages either using the Wi-Fi Direct Standard (see Wi-Fi Direct specification published in October 2010) and/or the IEEE 802.11 wireless standard (see IEEE 802.11-2007, published Mar. 8, 2007; IEEE 802.11n-2009, published October 2009), or a combination thereof. The wireless system (not shown) may include a transmitter and a receiver or a transceiver (not shown) capable of operating in a broad range of operating frequencies governed by the IEEE 802.11 wireless standards. The communication interfaces may utilize acoustic, radio frequency, optical, or other signals to exchange data between the consumer device 102 and another device, such as an access point, a host computer, a server, a router, a reader device, and the like. The networks 118 may include, but are not limited to, the Internet, a private network, a virtual private network, a wireless wide area network, a local area network, a metropolitan area network, a telephone network, and so forth.

The display 116 may include, but is not limited to, a liquid crystal display, a light-emitted diode display, or an E-Ink™ display as made by E Ink Corp. of Cambridge, Mass. The display 116 may be used to show content to a user in the form of text, images, or video. In certain instances, the display 116 may also operate as a touch screen display that may enable the user to initiate commands or operations by touching the screen using certain finger or hand gestures.

With continued reference to FIG. 1, one or more service provider server(s) 120 may also be in communication with the network(s) 118. The service provider server(s) 120 may also include processor(s) 122 and memory 124, which may store an operating system (0/S) 126, a database management system (DBMS) 128, and a lead distribution module 130.

The computer processors 122 may comprise one or more cores and may be configured to access and execute (at least in part) computer-readable instructions stored in the memory 124. The one or more computer processors 122 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The service provider server 120 may also include a chipset (not shown) for controlling communications between the one or more processors 122 and one or more of the other components of the service provider server 120. In certain embodiments, the service provider server 120 may be based on an Intel® architecture. The one or more processors 122 may also include one or more application-specific integrated circuits (ASICs) or application-specific standard products (ASSPs) for handling specific data processing functions or tasks.

The memory 124 may include one or more computer-readable storage media (CRSM). In some embodiments, the memory 124 may include non-transitory media such as random access memory (RAM), flash RAM, magnetic media, optical media, solid state media, and so forth. The memory 124 may be volatile (in that information is retained while providing power) or non-volatile (in that information is retained without providing power). Additional embodiments may also be provided as a computer program product including a transitory machine-readable signal (in compressed or uncompressed form). Examples of machine-readable signals include, but are not limited to, signals carried by the Internet or other networks. For example, distribution of software via the Internet may include a transitory machine-readable signal. Additionally, the memory 124 may store an operating system 126 that includes a plurality of computer-executable instructions that may be implemented by the computer processor to perform a variety of tasks to operate the interface(s) and any other hardware installed on the service provider server 120. The memory 124 may also store content that may be displayed by the service provider server 120 or transferred to other devices (e.g., headphones) to be displayed or played by the other devices. The memory 124 may also store content received from the other devices. The content from the other devices may be displayed, played, or used by the service provider server 120 to perform any necessary tasks or operations that may be implemented by the computer processor or other components in the service provider server 120.

The DBMS 128 stored in memory 124 may be configured to support functionality for accessing, retrieving, storing, and/or manipulating data stored in external datastore(s) (e.g., service provider datastore 131), and/or data stored in the memory 124. The DBMS 128 may use any of a variety of database models (e.g., relational model, object model, etc.) and may support any of a variety of query languages.

According to one or more embodiments, the DBMS 128 may be configured to store, retrieve, and/or otherwise access various data related to vehicle leads from the service provider datastore 131. For example, the DBMS 128 may be configured to retrieve and/or or store lead criteria information associated with a vehicle lead. Lead criteria information may include vehicle information associated with the vehicle lead, such as vehicle make, vehicle body style (e.g., sedan, coupe, wagon, truck, SUV, van, other) model, year, mileage, condition, trim, packages, options, drive train, and/or the like. Lead criteria information may also include consumer identification information, such as name, address, phone, email, or other personal identification information, contact information, geographic location, and/or the like. The lead criteria information may also include financial information associated with a consumer, such as credit information, payment information, trade-in information (e.g., a trade-in value of a vehicle of the consumer). The lead criteria information may also include other consumer preference information, such as certain price ranges, mileage ranges or model year ranges preferred by the consumer. In some implementations, the lead criteria information may also include dealer identification information, such as if a consumer (e.g., consumer 101) specifically identifies a dealer, other vehicle retailer of interest, vehicle retailer attributes, bank or finance company. It will be appreciated that the lead criteria information is not limited to the above examples and can include any other types of information related to a vehicle lead.

According to one or more embodiments, the DBMS 128 may also be configured to store lead age information associated with vehicle leads. For instance, the lead age information associated with a vehicle lead may indicate how long the vehicle lead has been active or over what period of time the lead information has been gathered. In some implementations, the lead age information may indicate how many days the lead has existed and without being sold to a dealer and/or other vehicle retailer. In some cases, the service provider server 120 may be configured to use the lead criteria information and the lead age information to determine quality scores associated with respective leads. Quality scores will be discussed in more detail below.

In certain embodiments, the DBMS 128 may also be configured to store lead preference information associated with one or more dealer and/or vehicle retailers. For instance, as part of interacting within the system 100, dealers may provide lead preference information to the service provider server 120, indicating the types of leads and/or quality of leads the dealer may desire within certain price ranges. For example, lead preference information may include data associated with quality scores and/or quality score ranges, vehicles attributes, vehicle price ranges (e.g., wholesale price and/or retail price), lead price ranges, selected periods of time, lead age, consumer demographics and/or the like. To this end, associations between lead preference information and different dealers may be stored by the DBMS 128 to reflect respective dealer preferences regarding leads. Furthermore, as described in more detail below, the service provider server 120 may be configured to identify one or more leads to provide to dealers based on their respective lead preference information.

Referring again to the service provider server(s) 120, the memory 124 may also include a lead distribution module 130. In general, the lead distribution module 130 may be configured to generate vehicle leads associated with one or more consumers 101, and to facilitate the distribution of the generated vehicle leads to one or dealers and/or vehicle retailers. Furthermore, the distribution of the vehicle leads may be performed based on certain preferences indicated by the dealers and/or vehicle retailers.

Therefore, according to certain embodiments, the lead distribution module 130 may be configured to access, obtain, and/or otherwise determine vehicle search information associated with one or more consumers. Vehicle search information may include data related to consumer identification information, consumer social media interaction, consumer search history, consumer financial information, or consumer browse history associated with consumer interaction with various vehicle websites and/or other sources. Based at least in part on the vehicle search information, the lead distribution module 130 may be configured to generate one or more vehicle leads.

For example, in some implementations, the lead distribution module 130 may be configured to perform consumer preference discovery operations related to one or more automotive websites. Consumer preference discovery operations may include one or more operations related to web crawling, cookies, pixel monitoring, and/or the like or any combination thereof. As a result of the consumer preference discovery operations, the lead distribution module 130 may be configured to identify consumer preference information related to the purchase and/or intended purchase of one or more vehicles. For example, the consumer preference discovery operations may identify one or more consumer searches and/or browsing histories related to vehicles offered by, advertised by, provided by, and/or otherwise associated with the automotive websites. For instance, as a result of performing web crawling operations on an automotive website, the lead distribution module 130 may determine that a particular consumer 101 searched for a black Toyota Camry at a certain price point. As such, the lead distribution module 130 may generate a corresponding vehicle lead to reflect the consumer's 101 interest in the black Toyota Camry. Furthermore, the lead distribution module 130 may also determine various other data obtained from the web crawling operations as lead criteria information (e.g., which may include information as described above with reference to the DBMS 128) associated with the vehicle lead. For example, the lead distribution module 130 may determine contact information associated with the consumer 101 (e.g., the consumer 101 may have filled out contact forms on the website) as well as vehicle attributes associated the browsed vehicle (e.g., trim, mileage, condition, options, etc.). Furthermore, the lead distribution module 130 may store an association between the generated vehicle lead and its associated lead criteria information in the DBMS 128 and/or datastore 131. Alternatively, the lead criteria information may be included as part of the generated vehicle lead.

As another example, the lead distribution module 130 may perform web crawling operations with respect to one or more social media websites. In certain cases, the web crawling operations may identify any mentions of vehicles and/or the desire to purchase a vehicle (e.g., from comments and/or posts made by potential consumers). Based on such information gathered from social media websites, the lead distribution module 130 may be configured to generate one or more vehicle leads. Furthermore, the lead distribution module 130 may be configured to update the lead criteria information over time. For example, the lead criteria information may be updated with further search information, browsing histories, and other consumer interaction with different vehicle websites or other sources.

According to one or more embodiments, the lead distribution module 130 may also be configured to determine quality scores associated with vehicle leads. To this end, the lead distribution module 130 may calculate quality scores based on lead criteria information and/or lead age. In some implementations, the quality score may indicate and/or otherwise measure a completeness of the vehicle lead (e.g., an amount and/or number of components included in the lead criteria information associated with the vehicle lead). As such, the greater the amount and/or number of components included in the lead criteria information d, the greater the quality score for the vehicle lead. Additionally, the components of the lead criteria information may also be weighted such that certain components of the lead criteria information may be more heavily weighted than other components. In other words, certain components of the lead criteria information may have a greater affect in determining the quality score than other components. For instance, contact information, such as a consumer's telephone number, email address, or the like may be associated with a greater weight than a vehicle trim preference of the consumer. As such, the lead distribution module 130 may be configured to determine an average of the weighted components included in the lead criteria information. The lead distribution module 130 may then determine the quality score of the vehicle lead using the average of the weighted components.

According to other implementations the quality score may also indicate a degree of match between the lead criteria information and the dealer preferences. For example, the more closely the lead criteria information matches the dealer preferences, the greater the lead quality score for the vehicle. To this end, the quality score for a particular lead may change depending on the dealer and may change based on different dealer preferences associated with different dealers. For example, the lead distribution module 130 may determine that the lead criteria information associated with the particular vehicle lead may match dealer preferences of a first dealer more closely than dealer preferences of a second dealer. The lead distribution module 130 may also determine a first quality score with respect to the vehicle for the first dealer and a second quality score with respect to the vehicle lead for the second dealer. Furthermore, based on the lead criteria information matching the dealer preferences of the first dealer more closely than the dealer preferences of the second dealer, the first quality score may be greater than the second quality score.

Conversely, a vehicle lead's quality score may be lowered with an increase in its age (e.g., as indicated by its lead age information).

In certain cases, the lead distribution module 130 may be configured to determine, based on a vehicle lead's quality score, whether the vehicle lead is salable. For example, if the vehicle lead's quality score is greater than or equal to a quality score threshold, the lead distribution module 130 may identify the vehicle lead as salable. Conversely, if the quality score is less than the quality score threshold, the vehicle distribution module 130 may identify the vehicle lead as non-salable.

According to one or more embodiments, the lead distribution module 130 may also be configured to receive and/or otherwise access lead preference information one or more dealer devices 138. As previously discussed, lead preference information associated with a particular dealer may include any type of data indicating the types of the leads that the dealer desires. For instance, a dealer may specify any received vehicle leads to be associated with certain vehicle attributes (e.g., make, model, year, etc.), to have certain types of user contact information (e.g., email, phone and/or zipcode), a certain vehicle price range, a vehicle mileage range, a model year range, and/or the like. As such, based on the parameters set forth in the lead preference information, the lead distribution module 130 may identify one or more vehicle leads associated with lead criteria information that match and/or substantially match those parameters (e.g., the lead preference information).

In certain implementations, the lead preference information may indicate a dealer's desire for vehicle leads that match vehicles that have been present in the dealer's inventory for a predetermined amount of time (e.g., inventory of a certain age). For instance, the dealer may specify a desire to receive vehicle leads that match vehicles that have been present in inventory for 15 days or more. It will be appreciated that the dealer may specify any inventory age criteria via the lead preference information. Thus, the lead distribution module 130 may provide an avenue to facilitate a dealer's selling of relatively old inventory.

In certain implementations, the lead distribution module 130 may take into account other factors, in addition to lead preference information, in determining which dealers to provide vehicle leads. For instance, in some cases, the lead distribution module 130 may provide leads to dealers based at least in part on profitability information associated with dealers. As such, the lead distribution module 130 may be configured to provide more leads to relatively high profitability dealers (i.e., dealers that are more profitable for the lead generation service provider).

In some implementations, vehicle leads may be provided to dealers based on a bidding framework in which dealers bid on vehicle leads. For example, the lead distribution module 130 may receive multiple lead preference information from multiple dealers. In addition, the lead distribution module 130 may receive various bids from the multiple dealers to obtain vehicle leads having lead criteria information that match the respective lead preference information. In certain cases, the lead distribution module 130 may identify a vehicle lead that may match lead preference information associated with multiple dealers. In order to determine which dealer to provide the vehicle lead, the lead distribution module 130 may identify the dealer that submitted the highest bid and provide the vehicle lead to the identified dealer. It will be appreciated, however, that in other implementations, vehicle leads may be distributed according to different bidding rules, such that multiple dealers may receive the same vehicle lead.

In other implementations, leads may be provided to dealers based on one or more pricing tiers. For example, a particular pricing tier may enable a dealer to purchase vehicle leads that are associated with quality scores less than or equal to a quality score threshold for that tier. To this end, more expensive tiers may be associated with vehicle leads having higher quality scores than less expensive tiers. It will be appreciated that the pricing schemes described herein are merely examples, and that any other type of pricing schemes and/or framework for determining which dealers to provide vehicle leads are also contemplated. For instance, leads could be sold in such a fashion as to maximize the conversion rate from lead to sale, to maximize the sale of leads, to drive greater interest in buying leads, etc.

According to certain embodiments, the lead distribution module 130 may also be configured to provide vehicle recommendations to dealers in addition to vehicle leads. For example, the lead distribution module 130 may determine that a vehicle lead is to be provided to a dealer. In addition, the lead distribution module 130 may also identify, from the lead criteria information associated with the vehicle lead, a desired vehicle. Furthermore, the lead distribution module 130 may access inventory data associated with the dealer's vehicle inventory and determine that the dealer's vehicle inventory does not include the desired vehicle. As a result, the lead distribution module 130 may access vehicle wholesale inventory data (e.g., stored in the datastore 131), such as data associated with vehicle wholesale inventory of an automotive auction provider and/or wholesale marketplace (e.g., dealer-to-dealer trade/sale platforms). The lead distribution module 130 may identify, from the vehicle wholesale inventory, one or more vehicles having attributes that match attributes of the desire vehicle (e.g., one or more vehicles that are similar to the desired vehicle). Furthermore, the lead distribution module 130 may also determine that the identified vehicles are also not included in the dealer's vehicle inventory. As such, the lead distribution module 130 may provide vehicle data associated with the identified vehicles to the dealer. In certain implementations, the lead distribution module 130 may provide a recommendation to the dealer to purchase the identified vehicles, such as from the vehicle wholesale inventory of one or more automotive auction providers and/or wholesale marketplaces.

Referring again to the service provider server(s) 120, the one or more network and I/O interfaces 132 may include one or more communication interfaces or network interface devices to provide for the transfer of data between the consumer device 102 and another device (e.g., network server) via one or more networks, such as 118. The communication interfaces may include, but are not limited to: personal area networks (PANs), wired local area networks (LANs), wireless local area networks (WLANs), wireless wide area networks (WWANs), and so forth. The consumer device 102 may be coupled to the network via a wired connection. However, the wireless system interfaces may include the hardware and software to broadcast and receive messages either using the Wi-Fi Direct Standard (see Wi-Fi Direct specification published in October 2010) and/or the IEEE 802.11 wireless standard (see IEEE 802.11-2007, published Mar. 8, 2007; IEEE 802.11n-2009, published October 2009), or a combination thereof. The wireless system (not shown) may include a transmitter and a receiver or a transceiver (not shown) capable of operating in a broad range of operating frequencies governed by the IEEE 802.11 wireless standards. The communication interfaces may utilize acoustic, radio frequency, optical, or other signals to exchange data between the service provider server(s) 120, and another device, such as an access point, a host computer, a server, a router, a reader device, and the like. The networks 118 may include, but are not limited to, the Internet, a private network, a virtual private network, a wireless wide area network, a local area network, a metropolitan area network, a telephone network, and so forth.

The display 134 may include, but is not limited to, a liquid crystal display, a light-emitting diode display, or an E-Ink™ display as made by E Ink Corp. of Cambridge, Mass. The display 134 may be used to show content to a user in the form of text, images, or video. In certain instances, the display 134 may also operate as a touch screen display that may enable the user to initiate commands or operations by touching the screen using certain finger or hand gestures.

With continued reference to FIG. 1, the system 100 may also include one or more dealer device(s) 138. In general, the dealer device 138 may refer to any type of electronic device, and, more particularly, may refer to one or more of the following: a wireless communication device, a portable electronic device, a telephone (e.g., cellular phone, smart phone), a computer (e.g., laptop computer, tablet computer), a wearable computer device, a portable media player, a personal digital assistant (PDA), or any other electronic device having a networked capability. The dealer device(s) 138 may include one or more computer processors 140, and a memory 142 storing an operating system (0/S) 144 and a dealer module 146. In addition, the dealer device(s) 138 may include one or more network and I/O interfaces 148, and a display 150. In certain embodiments, the dealer device(s) 138 may include one or more sensors capable of gathering information associated with a present environment of the dealer device(s) 138, or similar hardware devices, such as a camera, microphone, antenna, a gesture capture or detection device, or Global Positioning Satellite (GPS) device.

As used herein, a dealer may refer to a dealer/dealership, an original equipment manufacturer, a rental car company, and/or any other entity having an inventory of vehicles.

The computer processors 140 may comprise one or more cores and may be configured to access and execute (at least in part) computer-readable instructions stored in the memory 142. The one or more computer processors 140 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The dealer device 138 may also include a chipset (not shown) for controlling communications between the one or more processors 140 and one or more of the other components of the dealer device 138. In certain embodiments, the dealer device 138 may be based on an Intel® architecture or an ARM® architecture, and the processor(s) and chipset may be from a family of Intel® processors and chipsets. The one or more processors 140 may also include one or more application-specific integrated circuits (ASICs) or application-specific standard products (ASSPs) for handling specific data processing functions or tasks.

The memory 142 may include one or more computer-readable storage media (CRSM). In some embodiments, the memory 142 may include non-transitory media such as random access memory (RAM), flash RAM, magnetic media, optical media, solid state media, and so forth. The memory 142 may be volatile (in that information is retained while providing power) or non-volatile (in that information is retained without providing power). Additional embodiments may also be provided as a computer program product including a transitory machine-readable signal (in compressed or uncompressed form). Examples of machine-readable signals include, but are not limited to, signals carried by the Internet or other networks. For example, distribution of software via the Internet may include a transitory machine-readable signal. Additionally, the memory 142 may store an operating system 144 that includes a plurality of computer-executable instructions that may be implemented by the computer processor to perform a variety of tasks to operate the interface(s) and any other hardware installed on the dealer device 138. The memory 142 may also store content that may be displayed by the dealer device 138 or transferred to other devices (e.g., headphones) to be displayed or played by the other devices. The memory 142 may also store content received from the other devices. The content from the other devices may be displayed, played, or used by the dealer device 138 to perform any necessary tasks or operations that may be implemented by the computer processor or other components in the dealer device 138.

The memory 142 may also include an operating system (O/S) 144, which may provide an interface between other application software executing on the dealer device 138 and hardware resources of the dealer device 138. More specifically, the operating system 144 may include a set of computer-executable instructions for managing hardware resources of the dealer device 138 and for providing common services to other application programs (e.g., managing memory allocation among various application programs). The operating system 144 may include any operating system now known or which may be developed in the future including, but not limited to, any bidder operating system, any server operating system, any mainframe operating system, or any other proprietary or freely available operating system.

The memory 142 may also include a dealer module 146, which may be configured to interact with users of the dealer device 138. In certain embodiments, the dealer module 146 may provide a user interface to facilitate such interaction. For instance, the dealer module 146 may enable the dealer to select one or more dealer preferences to indicate the types of vehicle leads desired by the user. To this end, the dealer module 146 may be configured to collect and transmit dealer preference information associated with the selected preferences to the service provider server(s) 120. According to one or more embodiments, dealer preferences may include, but are not limited to, profitability preferences and/or thresholds, vehicle attributes, lead age information, lead quality scores and/or thresholds, and/or the like.

Referring again to the dealer device 138, the one or more network and I/O interfaces 148 may include one or more communication interfaces or network interface devices to provide for the transfer of data between the dealer device 138 and another device (e.g., network server) via one or more networks, such as 118. The communication interfaces may include, but are not limited to: personal area networks (PANs), wired local area networks (LANs), wireless local area networks (WLANs), wireless wide area networks (WWANs), and so forth. The dealer device 138 may be coupled to the network via a wired connection. However, the wireless system interfaces may include the hardware and software to broadcast and receive messages either using the Wi-Fi Direct Standard (see Wi-Fi Direct specification published in October 2010) and/or the IEEE 802.11 wireless standard (see IEEE 802.11-2007, published Mar. 8, 2007; IEEE 802.11n-2009, published October 2009), or a combination thereof. The wireless system interfaces may also include cellular standards such as Long-Term Evolution (LTE), LTE-Advanced, Global System for Mobile (GSM), code division multiple access (CDMA), and/or the like. The wireless system (not shown) may include a transmitter and a receiver or a transceiver (not shown) capable of operating in a broad range of operating frequencies governed by the IEEE 802.11 wireless standards. The communication interfaces may utilize acoustic, radio frequency, optical, or other signals to exchange data between the dealer device 138 and another device, such as an access point, a host computer, a server, a router, a reader device, and the like. The networks 118 may include, but are not limited to, the Internet, a private network, a virtual private network, a wireless wide area network, a local area network, a metropolitan area network, a telephone network, and so forth.

The display 150 may include, but is not limited to, a liquid crystal display, a light-emitting diode display, or an E-Ink™ display as made by E Ink Corp. of Cambridge, Mass. The display 150 may be used to show content to a user in the form of text, images, or video. In certain instances, the display 150 may also operate as a touch screen display that may enable the user to initiate commands or operations by touching the screen using certain finger or hand gestures.

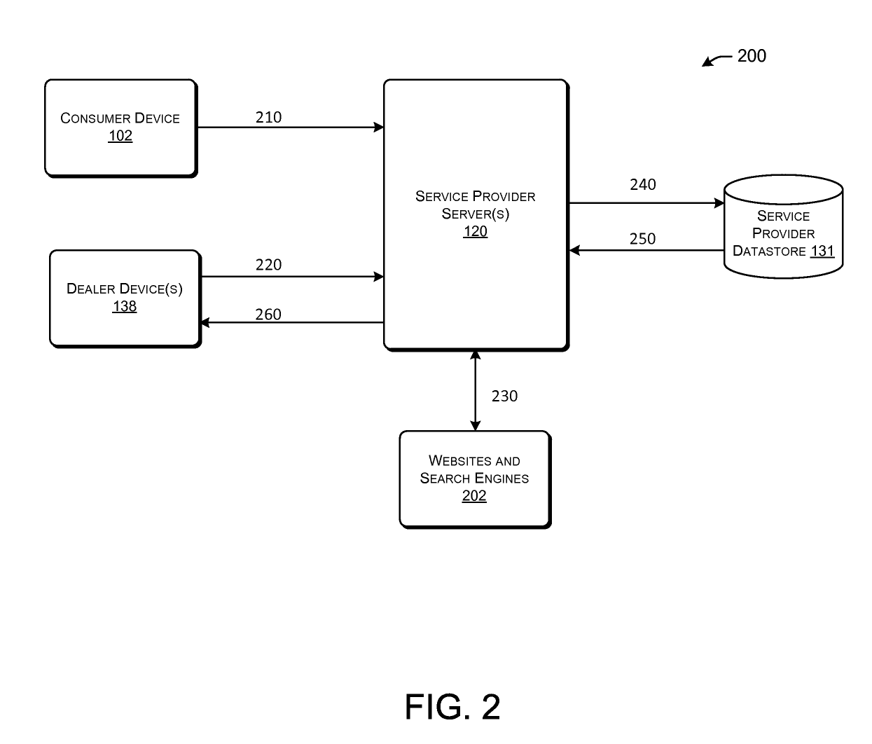

Referring now to FIG. 2, a diagram of a data flow 200 is illustrated for facilitating lead distribution in accordance with one or more example embodiments. According to the data flow 200, a consumer device 102 may interact 210 with various websites and/or online search engines 202. For example, a consumer of the consumer device 102 may browse to automotive websites and or search for information associated with one or more vehicles using a search engine. In certain cases, the consumer may also interact with various social media sites (e.g., posting comments, status updates, etc.) and indicate an interest in one or more vehicles.

According to certain implementations, the service provide server(s) 120 may track 220 and/or capture the consumer web interactions 210 associated with vehicles. For example, the service provider server(s) may perform (e.g., via the lead distribution module 130) one or more web crawling operations to determine vehicle search information related to vehicles. The vehicle search information may include the consumer interactions 210 with the various websites and search engines 202. Furthermore, based on the vehicle search information, the service provider server(s) 120 may be configured to generate one or more vehicle leads. The service provider server(s) 120 may also be configured to store 230 the vehicle leads and any associated information (e.g., lead criteria information and/or lead age information) in the service provider datastore 131.

In addition, one or more dealer devices 138 may be configured to transmit 240 and/or otherwise provide lead preference information to the service provider server(s) 120. As discussed above, the lead preference information may indicate the types of vehicle leads desired by one or more dealers associated with the dealer device(s) 138. To this end, the service provider server(s) 120 may access 250 the datastore 131 to determine one or more vehicle leads that match and/or correspond to the lead preference information provided by the dealer device(s) 138. Upon identifying the one or more corresponding vehicle leads, the service provider server(s) 120 may transmit 260 the identified leads to the dealer device(s) 138.

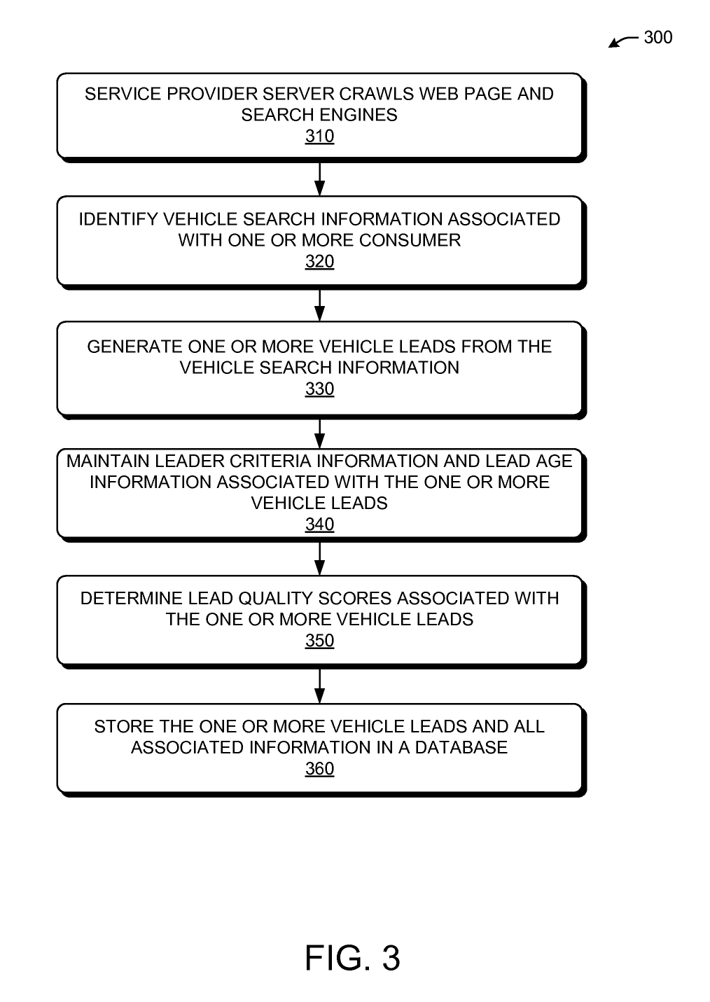

FIG. 3 illustrates a method 300 for generating vehicle leads in accordance with one or more example embodiments. The method 300 may begin in block 310, where a service provider server 120 and/or a lead distribution module 130 may perform web crawling operations with respect various automotive websites and/or online search engines. In block 320, based on the web crawling operations, the service provider server 120 and/or the lead distribution module 130 may identify vehicle search information associated with one or more consumers 320.

In block 330, the service provider server(s) 120 and/or the lead distribution module 130 may generate one or more vehicle leads based at least in part on the vehicle search and browsing information 330. In block 340, the service provider server(s) 120 and/or the lead distribution module 130 may determine lead criteria information and/or lead age information associated with the generated vehicle leads. Lead criteria information and lead age information are discussed in more detail above with reference to FIG. 1. In block 350, the service provider server(s) 120 and/or the lead distribution module 130 may determine lead quality scores associated with the generated vehicle leads. In block 360, the service provider server(s) 120 and/or the lead distribution module 130 may be configured to store associations between the generated vehicle leads and their associated information (e.g., lead criteria information, lead age information, and/or quality scores) in a database and/or datastore 131.

In certain implementations, the service provider server(s) 120 and/or the lead distribution module 130 may also be configured to update lead criteria information associated with a lead based on any relevant new information that is discovered (e.g., via web crawling operations). Similarly, lead age information may also be updated, such as periodically to reflect the passage of time. To this end, as the lead criteria information and the lead age information are updated, the lead distribution module 130 may also be configured to update and/or other adjust the quality score associated with the vehicle lead.

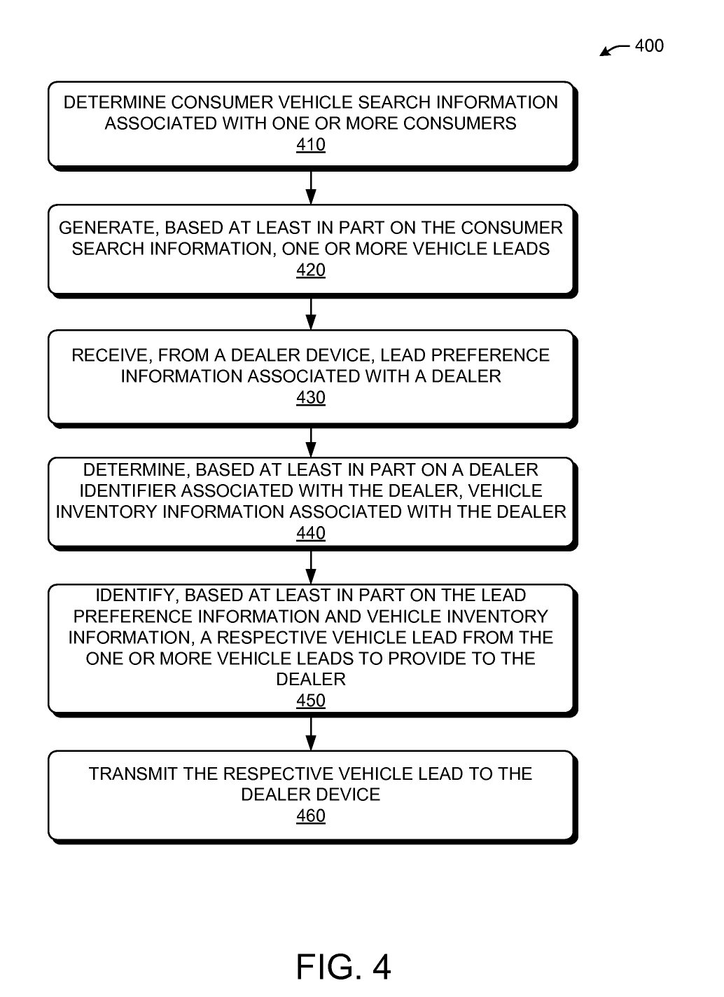

Referring now to FIG. 4, a method 400 for facilitating lead distribution is provided in accordance with one or more example embodiments. The method may begin in block 410, where a computer, such as a service provide server 120, may determine vehicle search information associated with one or more consumers. In block 420, the computer may generate, based at least in part on the vehicle search information, one or more vehicle leads. In block 430, the computer may receive, from a dealer device (e.g., dealer device 138), lead preference information associated with a dealer.

In block 440, the computer may identify, based at least in part on the lead preference information, a respective vehicle lead from the one or more vehicle leads to provide to the dealer and/or dealer device. In block 450, the computer may be configured to transmit the respective vehicle lead to the dealer device.

Certain embodiments of the present disclosure are described above with reference to block and flow diagrams of systems and methods and/or computer program products according to example embodiments of the present disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the present disclosure.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the present disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the present disclosure have been described in connection with what is presently considered to be the most practical and various embodiments, it is to be understood that the present disclosure is not to be limited to the disclosed embodiments, but is intended to cover various modifications and equivalent arrangements included within the scope of the appended claims. Although specific terms are employed herein, they are used in a generic and descriptive sense only and not for purposes of limitation.

This written description uses examples to disclose certain embodiments of the present disclosure, including the best mode, and also to enable any person skilled in the art to practice certain embodiments of the present disclosure, including making and using any devices or systems and performing any incorporated methods. The patentable scope of certain embodiments of the present disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method, comprising:
accessing, by a server comprising one or more processors, lead preference information associated with a dealer, the lead preference information indicating one or more desired vehicle lead attributes by the dealer;
aggregating vehicle search information associated with one or more consumers;
generating, based at least in part on the vehicle search information, one or more vehicle leads;
identifying a respective vehicle lead from the one or more vehicle leads, wherein the respective vehicle lead comprises lead criteria information and lead age information, and wherein the respective vehicle lead is associated with a respective consumer of the one or more consumers;
comparing the lead criteria information and the lead age information with the lead preference information associated with the dealer;
determining, based at least in part on the comparison, that the respective lead is to be provided to the dealer; and
transmitting the respective vehicle lead to a dealer device associated with the dealer.

2. The method of claim 1, wherein comparing the lead criteria information and the lead age information with the lead preference information further comprises:
determining, based at least in part on the lead criteria information and the lead age information, a quality score associated with the respective vehicle lead.

3. The method of claim 2, wherein determining the quality score further comprises:
identifying one or more weighted components included in the lead criteria information; and
determining an average of the one or more weighted components, wherein the quality score is directly proportional to the average.

4. The method of claim 2, wherein determining the quality score further comprises:
determining a degree of match between the lead criteria information and the dealer preferences, wherein the quality score is directly proportional to the degree of match.

5. The method of claim 4, wherein determining the degree of match further comprises:
identifying, based at least in part on the lead criteria information, a desired vehicle and a price range associated with the desired vehicle;
determining, an estimated profitability for the dealer for selling the desired vehicle within the price range; and
determining whether the estimated profitability is greater than or equal to a profitability threshold.

6. The method of claim 2, wherein determining the quality score further comprises:
determining, based at least in part on the lead criteria information and lead age information, a conversion probability associated with the respective lead, wherein the quality score is directly proportional to the conversion probability.

7. The method of claim 2, further comprising:
determining that the quality score associated with the vehicle lead is greater than a score threshold; and
identifying, based at least in part on the determination, the vehicle lead as salable.

8. The method of claim 1, wherein the respective lead criteria information comprises data associated with at least one of vehicle make, vehicle model, vehicle year, vehicle mileage, vehicle trim, vehicle body style, consumer identification information, or dealer identification information.

9. The method of claim 1, wherein the vehicle search information comprises data associated with at least one of consumer identification information, consumer social media interaction, consumer search history, consumer financial information, or consumer browsing history.

10. The method of claim 1, wherein the lead preference information comprises data associated with at least one of a quality score, geographic region, vehicle data, vehicle price range, lead price range, time period, lead age, or consumer demographics.

11. The method of claim 1, further comprising:
identifying, based at least in part on the lead criteria information associated with the respective vehicle lead, a desired vehicle;
determining that the desired vehicle is unavailable in a vehicle inventory associated with the dealer;
accessing vehicle wholesale inventory data associated with at least one vehicle wholesaler;
identifying, based at least in part on the vehicle wholesale inventory data, one or more similar vehicles to the desired vehicle, wherein the identified one or more similar vehicles are not included in the vehicle inventory; and
transmitting, to the dealer device, vehicle data associated with the one or more similar vehicles.

12. A service provider server, comprising:
at least one processor;
at least one memory storing computer-readable instructions, that when executed by the at least one processor, cause the at least one processor to:
access lead preference information associated with a dealer, the lead preference information indicating one or more desired vehicle lead attributes by the dealer;
aggregate vehicle search information associated with one or more consumers;
generate, based at least in part on the vehicle search information, one or more vehicle leads;
identify a respective vehicle lead from the one or more vehicle leads, wherein the respective vehicle lead comprises lead criteria information and lead age information, and wherein the respective vehicle lead is associated with a respective consumer of the one or more consumers;
compare the lead criteria information and the lead age information with the lead preference information associated with the dealer;
determine, based at least in part on the comparison, that the respective lead is to be provided to the dealer; and
transmit the respective vehicle lead to a dealer device associated with the dealer.

13. The service provider server of claim 12, wherein the computer-executable instruction to compare the lead criteria information and the lead age information with the lead preference information further cause the at least one processor to:
determine, based at least in part on the lead criteria information and the lead age information, a quality score associated with the respective vehicle lead.

14. The service provider server of claim 13, wherein the computer-executable instructions to determine the quality score further cause the at least one processor to:
identifying one or more weighted components included in the lead criteria information; and
determine an average of the one or more weighted components, wherein the quality score is directly proportional to the average.

15. The service provider server of claim 13, wherein the computer-executable instructions to determine the quality score further cause the at least one processor to:
determine a degree of match between the lead criteria information and the dealer preferences, wherein the quality score is directly proportional to the degree of match.

16. The service provider server of claim 15, wherein the wherein the computer-executable instructions to determine the degree of match further cause the at least one processor to:
identify, based at least in part on the lead criteria information, a desired vehicle and a price range associated with the desired vehicle;
determine, an estimated profitability for the dealer for selling the desired vehicle within the price range; and
determine whether the estimated profitability is greater than or equal to a profitability threshold.

17. The service provider server of claim 13, wherein the computer-executable instructions to determine the quality score further cause the at least one processor to:
determine, based at least in part on the lead criteria information and lead age information, a conversion probability associated with the respective lead, wherein the quality score is directly proportional to the conversion probability.

18. The service provider server of claim 13, wherein the computer-executable instructions further cause the at least one processor to:
determine that the quality score associated with the vehicle lead is greater than a score threshold; and
identify, based at least in part on the determination, the vehicle lead as salable.

19. The service provider server of claim 12, wherein the computer-readable instructions further cause the at least one processor to:
identify, based at least in part on the lead criteria information associated with the respective vehicle lead, a desired vehicle;
determine that the desired vehicle is unavailable in a vehicle inventory associated with the dealer;
access vehicle wholesale inventory data associated with at least one vehicle wholesaler;
identify, based at least in part on the vehicle wholesale inventory data, one or more similar vehicles to the desired vehicle, wherein the identified one or more similar vehicles are not included in the dealer's inventory; and
transmit, to the dealer device, vehicle data associated with the one or more similar vehicles.

20. A non-transitory computer-readable medium storing computer-executable instructions that when executed by one or more processors, cause the one or more processors to:
access lead preference information associated with a dealer, the lead preference information indicating one or more desired vehicle lead attributes by the dealer;
aggregate vehicle search information associated with one or more consumers;
generate, based at least in part on the vehicle search information, one or more vehicle leads;
identify a respective vehicle lead from the one or more vehicle leads, wherein the respective vehicle lead comprises lead criteria information and lead age information, and wherein the respective vehicle lead is associated with a respective consumer of the one or more consumers;
compare the lead criteria information and the lead age information with the lead preference information associated with the dealer;
determine, based at least in part on the comparison, that the respective lead is to be provided to the dealer; and
transmit the respective vehicle lead to a dealer device associated with the dealer.
